(19) United States
(12) Patent Application Publication
(10) Pub. No.: US 2006/0087802 A1
(43) Pub. Date: Apr. 27, 2006

(54) Encapsulated case of display

(76) Inventor: Yung-Feng Kao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/972,344

(22) Filed: Oct. 26, 2004

(51) Int. Cl. G06F 1/16

(52) U.S. Cl. 361/681

(57) ABSTRACT

The present invention discloses an encapsulated case of display. The encapsulated case comprises a first cover, a second cover, and at least one anchor bar to encapsulate a display apparatus. The peripheral of the first cover comprises a plurality of first anchor structures to fix the display apparatus. Besides, at least one of the anchor bars also comprises a plurality of second anchor structures to fix the display apparatus. Furthermore, the material of these anchor structures comprises flexible rubber and foam to fit in different displays apparatus with different sizes.

### BACKGROUND OF THE INVENTION

1. Field of the Invention

The present invention generally relates to encapsulated case, and more particularly to encapsulated case of display.

2. Description of the Prior Art

The applications and requirements of liquid crystal displays and plasma displays grow day after day in modem life. Since the renewal cycle time of inner liquid crystal panels and plasma panels, which differs slightly in various sizes, is getting shorter and shorter, the encapsulated cases of display are also required to change in order to fit in the sizes of inner panels. Hence, the price competency would be weakening by the production expanse of new cases for each new inner panel. In summarized, it is desired to have a general encapsulated case of display to fit various sizes of different panels in order to improve price competency.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention discloses an encapsulated case of display. The encapsulated case comprises a first cover, a second cover, and at least one anchor bar to encapsulate a display apparatus. The peripheral of the first cover comprises a plurality of first anchor structures to fix the display apparatus. Besides, at least one of the fix the display apparatus. Furthermore, the material of these anchor structures comprises flexible rubber and foam to fit in different displays apparatus with different sizes.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates an encapsulated case in accordance with an embodiment of the present invention;

FIG. 2 is a diagram depicts a anchor bar shown in FIG. 1; and

FIG. 3 is a another diagram shows the embodiment shown in FIG. 1.

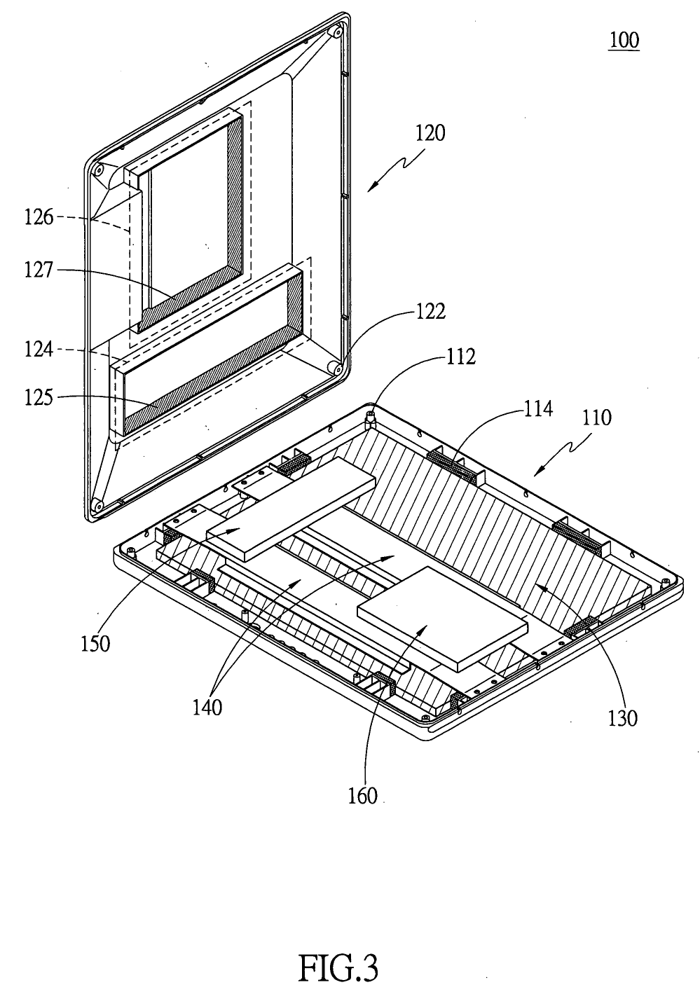

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

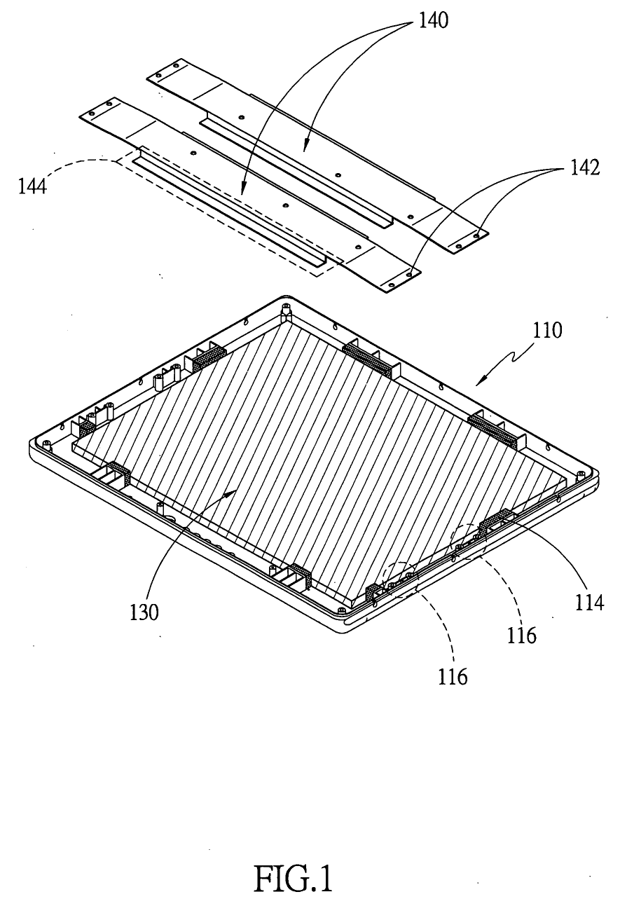

Please refer to FIG. 1, which illustrates an encapsulated case 100 in accordance with an embodiment of the present invention. The encapsulated case 100 comprises a first cover 110, a second cover 120, and at least an anchor bar 140. In this regards, a display apparatus 130 is encapsulated and covered by the first cover 110 and the second cover 120. As mentioned in prior art, the display apparatus 130 may be a liquid crystal panel, a plasma panel, or any other apparatus which is suitable for being encapsulated in the encapsulated case 100.

In this embodiment, the first cover 110 comprises a plurality of first connecting structures 112, and the second cover 120 also comprises a plurality of second connecting structures 122, which locate at the corresponding positions of the plurality of first connecting structures 112. In the consequence, the first cover 110 can be closely connected by the connections of the plurality of first connecting structures 112 and the plurality of second connecting structures 122. In an example of the embodiment, the plurality of first connecting structures 112 are holes within screw threads, and so are the plurality of second connecting structures 122. Therefore the first cover 110 and the second cover 120 can be closely tied together by screwing the first and second connecting structures 112 and 122. The present invention does not limit the number of the first and corresponding second connecting structures 112 and 122. It only required that the connecting structures 112 and 122 located along the edges of the first and second cover 110 and 120.

In this embodiment, the first cover 110 comprises a plurality of first anchor structures 114 to fix the display apparatus 130. The material of the plurality of first anchor structures 114 comprises flexible rubber and foam. The sizes of the first anchor structures 114 are corresponding to the different display apparatus 130 with different sizes. If the size variation of the different display apparatus 130 is within a certain range, it is not required to change the plurality of first anchor structures 114 to fix these various display apparatus 130.

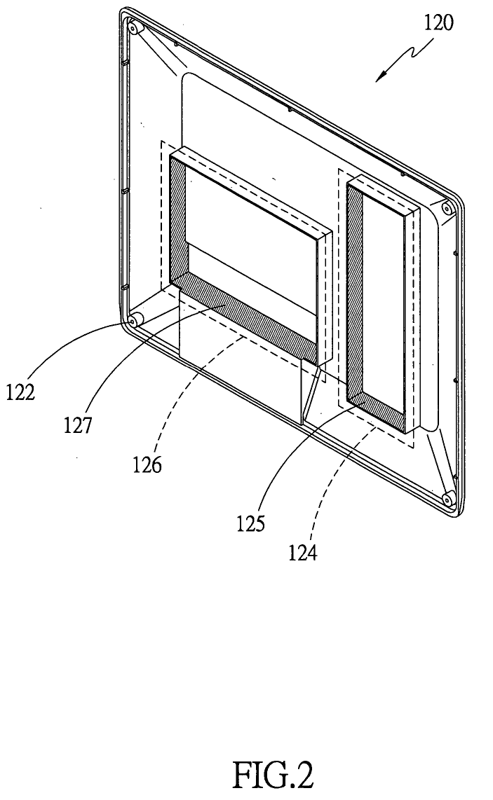

Please refer to FIG. 2, which shows details of the anchor bar 140 shown in the FIG. 1. Since the encapsulation of the first cover 110 and the second cover 120 cannot fit the display apparatus 130 closely, it is required to have the anchor bar 140 to fix the display apparatus 130. The two ends of the anchor bar 140 comprise a plurality of third connecting structures 142. And the first cover 110 also comprises a plurality of fourth connecting structures 116 at the positions corresponding to the plurality of third connecting structures 142. Therefore, the first cover 110 and the anchor bar 140 can be tied closely by these connecting structures 116 and 142.

In a better example of this embodiment, the two sides of anchor bar 140 further comprise a plurality of second anchor structures 144. When the first cover 110 and the second cover 120 tied, the plurality of second anchor structures 144 can be anchored on the surface of the display apparatus 130. Hence the anchor bar 140 can fix the display apparatus 130 more closely. In this example, the plurality of second anchor structures 144 is bending structures shown in the FIG. 2. In another better example, the material of the plurality of second anchor structures 144 comprises flexible rubber and foam.

In addition to the display apparatus 130, the encapsulated case 100 may encapsulate a power module 150 and/or a display control module 160, too. In the embodiment, the power module 150 and/or the display control module 160 are positioned above the anchor bar 140. Furthermore, the second cover 120 comprises a power module space 124 and a display control module space 126 which locates corresponding to the power module 150 and the display control module 160. Since the display apparatus 130 is served by the power module 150 and the display control module 160, the power module space 124 and the display control module space 126 may be larger in order to contain various sizes of the power module 150 and the display control module 160. Besides, in order to follow the regulations of electromagnetic and radiation, the power module space 124 and the display control module space 126 may comprise conducting material to have screening effect on the power module 150 and the display control module 160. In the consequence, it restricts the leakage of electromagnetic fields. In a better example of the embodiment, the conducting material of the power module space 124 is light-weighted aluminum foil, and the conducting material of the display control module space 126 is light-weighted aluminum foil, too. Moreover, the first cover 110 and the second cover 120 of the encapsulated case 100 are also made of conducting material to provide overall screening effect.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. An encapsulated case of display, the encapsulated case comprise
a first cover, wherein the first cover contains a display apparatus and further comprise a plurality of connecting structures and a plurality of first anchor structures to fix said display apparatus; and
a second cover, wherein the second cover comprises a plurality of second connecting structures which locates corresponding to said plurality of first connecting structures, said first cover and said second cover can be connected closely by the connections of said plurality of first connecting structures and said plurality of second connecting structures.

2. The encapsulated case of claim 1, the encapsulated case further comprises at least one anchor bar to fix said display apparatus.

3. The encapsulated case of claim 2, wherein the two ends of said anchor bar comprise a plurality of third connecting structures, said first cover also comprises a plurality of fourth connecting structures which locate corresponding to said plurality of third connecting structures, said anchor bar and said first cover can be connected closely by the connections of said plurality of third connecting structures and said plurality of fourth connecting structures.

4. The encapsulated case of claim 2, wherein the two sides of said anchor bar comprise a plurality of second anchor structures, said plurality of second anchor structures are anchored to the surface of said display apparatus such that said anchor bar tied to said display apparatus more closely.

5. The encapsulated case of claim 4, wherein said plurality of second anchor structures are bending structures.

6. The encapsulated case of claim 4, wherein the material of said plurality of second anchor structures comprise flexible rubber and foam.

7. The encapsulated case of claim 1, wherein the material of said plurality of first anchor structures comprise flexible rubber and foam.

8. The encapsulated case of claim 1, wherein said second cover comprises a power module space to contain a power module above said anchor bar.

9. The encapsulated case of claim 1, wherein said second cover comprises a display control module space to contain a display control module above said anchor bar.

10. The encapsulated case of claim 8, wherein the material of said power module space comprise a conducting material to provide screening effect.

11. The encapsulated case of claim 10, wherein said conducting material comprises an aluminum foil.

12. The encapsulated case of claim 9, wherein the material of said display control module space comprise a conducting material to provide screening effect.

13. The encapsulated case of claim 12, wherein said conducting material comprises an aluminum foil.

14. The encapsulated case of claim 1, wherein the material of said second cover comprises an aluminum foil.

15. The encapsulated case of claim 1, wherein the material of said first cover comprises an aluminum foil.
